(19) United States
(12) Patent Application Publication
(10) Pub. No.: US 2006/0105800 A1
(43) Pub. Date: May 18, 2006

(54) Timer-based ringer control for mobile phones

(76) Inventor: Yang-kyung Lee, Englewood Cliffs, NJ (US)

Correspondence Address: Yang-Kyung Lee, 2561 Park Ave., Laguna Beach, CA, 92651, US

(21) Appl. No.: 10/991,152

(22) Filed: Nov. 17, 2004

(51) Int. Cl. H04M 1/00

(52) U.S. Cl. 455/550.1

(57) ABSTRACT

Disclosed is an apparatus and method for temporarily turning off the ringer of a mobile phone for a specific amount of time as it is carried to public places and events, such as churches, movie theaters and weddings. The user can quickly turn off the ringer by using a special key on the phone or by selecting a particular time amount from a menu of options. The invention is applicable to other portable communication devices, such as pagers, PDAs, laptops, and tablet PCs.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to mobile phones and more particularly to methods and structures for controlling ringers in mobile phones.

As the number of people using mobile/cell phones grows, it is becoming increasingly annoying to hear them ring at certain inappropriate public events/places, such as movies, concerts, churches, weddings, funerals, meetings and conferences. To address this problem, some people turn off their phones or set the ringer to either silence or vibration mode before going into such places/events. However, they often forget to turn the ringer back on after they leave the place/event, thereby missing important calls for hours without realizing.

Some modern cell phones have the feature whereby the user can define and/or schedule a particular profile for the ringer. For example, the Nokia 6385 phone allows the user to select the Silent mode for a specific start and end times. To accomplish this, the user has to enter the following long series of keystrokes:
1. At the Start screen, press Menu
2. Select 3 for Profiles
3. Scroll to the profile you wish to activate (Silent) and set for timed expiration, and then press Select
4. Scroll to Timed and press Select
5. Enter the time for the profile to expire and press OK (you may also be required to select either AM or PM)

This feature is difficult to use as the user has to maneuver through a number of general menu screens (not a special key primarily designated for this purpose) and enter the specific start and end times in numeric form (i.e., not the “amount” of time) during which the ringer is to be turned off.

Microsoft-powered Smartphone, available from Samsung and Motorola, offers a feature where the user can adjust the ringer volume for certain time periods, but only in accordance with the user's predefined schedule in the integrated personal digital assistant (PDA). If the schedule in the PDA indicates that the user is in a meeting, the ringer will be turned off until the meeting is over. However, it requires that the user plan and specify the meeting times in advance. If the user's schedule changes and is somehow not updated, the ringer can still ring at inappropriate times/places. Further, as the timer cannot be turned on directly without the use of the PDA function, it is impractical for extemporaneous use.

Some telephone switching systems for landline phones offer “Do Not Disturb” feature (under a name “Centrex”) to prevent ringing signals from being sent to the landline phone during a specified time period but require that the user enter a series of keystrokes to activate and deactivate and/or enter the start and end times manually. U.S. Pat. No. 4,480,154 describes an automatic telephone silencer that works under the control of a 24-hour timer and requires the user to enter the start and end times of the silencer (e.g., before going to sleep). U.S. Pat. No. 5,812,648 describes a telephone ringer control device for selectively activating and deactivating the ringer based on the user-specified time periods. Both the '154 and '648 patents are limited to landline phones and require a large number of keystrokes to activate the timer. U.S. Pat. Nos. 5,317,632 and 4,405,839 describe a timed telephone silencer that connects between the telephone line from the wall jack and the telephone. They are also limited to landline phones and are standalone devices external to the phone. U.S. Pat. No. 4,924,499 describes a timer control for various telephone functions, including the ringer, but is also limited to landline phones. None of these prior patents and systems deal with the issue of portable cell telephones being carried to public places that have certain noise restrictions and hence the need to enable the users of such phones to quickly turn off the ringer as needed without prior planning.

What is needed is a method and apparatus that overcomes these limitations of the prior art so that the user of a cell phone can quickly turn off the ringer in order not to disturb others as the phone is carried to various public places/events.

### BRIEF SUMMARY OF THE INVENTION

Accordingly, it is an object of the present invention to provide a method and apparatus for quickly turning off the ringer of a cellular phone (and more broadly a portable communication device) temporarily in order not to disturb others in certain public places or events. It is another object of the present invention to provide a method and apparatus for turning off the ringer of a cell phone without entering the start and/or end times of the period during which the ringer is to be turned off. It is another object of the present invention to provide a special key to temporarily turn off the ringer of a cell phone. It is another object of the present invention to provide a special key combined with the ringer volume control key to turn off the ringer of a cell phone for a given time period. It is another object of the present invention to provide a timer mechanism for turning off the ringer of a cell phone on an ad hoc basis, not necessarily at the same time every day (e.g., during the sleeping hours) or without advance planning.

In accordance with one aspect of this invention, the cell phone user can temporarily turn off the ringer quickly and extemporaneously by using a special key on the phone. The key may be on the side of the phone, on the keypad, or even on the face of a flip or sliding phone for easy access. Another aspect of the invention is to allow the user to enter the amount of the timer instead of the start and/or end times of the timer during which the ringer is to be turned off. For example, the user may simply enter the duration of the timer in hour, e.g., “1” for 1 hour, instead of the numeric designation of the start and/or end times (e.g., “3” followed by “30” and then “PM” to enter 3:30 PM). The term “temporarily” in this specification refers to the fact that the ringer is turned back on automatically once the timer expires.

### BRIEF DESCRIPTION OF THE SEVERAL VIEWS OF THE DRAWINGS

FIG. 1 is a simplified block diagram of the architecture of a mobile phone embodying the invention.

FIGS. 2A-2C show different methods of selecting a specific amount of time during which the ringer is to be temporarily turned off.

FIGS. 3A-3C show different embodiments of the special key used for timer activation (“timer key”). FIG. 3A is an embodiment the timer key that is in the keypad area. FIG. 3B is an embodiment of the timer key located on the side of the phone. FIG. 3C is the top face view of a telephone in closed position showing the timer key.

FIG. 4 shows an example of a call flow according to this invention.

### DETAILED DESCRIPTION OF THE INVENTION

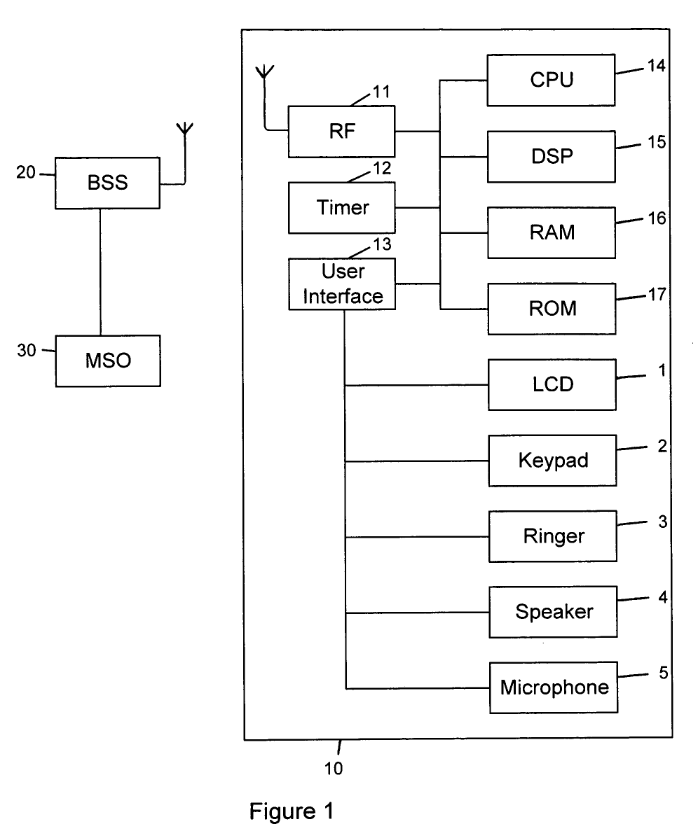

A simplified functional block diagram of a cell telephone 10 embodying this invention is shown in FIG. 1. Cellular phones, or cell phones in short, in this specification refers to and is used interchangeably with wireless phones/handsets, mobile phones, PCS phones, GSM phones and CDMA phones, and may be integrated with other portable electronic devices, such as PDAs, tablet PCs, laptops and pagers. The cell phone comprises a radio frequency (RF) module 11, an RF antenna 11A, and a user interface (U/I) module 13, which interfaces with an LCD display 1, a keypad 2, a ringer/vibrator 3, a speaker 4, and a microphone 5. Both the RF module 11 and the U/I module 13 communicate with a central processing unit (CPU) 14, which controls the overall operation of the phone. A digital signal processor (DSP) 15 is provided to perform dedicated tasks such as speech encoding and decoding. Operating software is stored in a read only memory (ROM) 17, while user-specific software like names and phone numbers is stored in a random access memory (RAM) 16. Timer 12 is used to keep track of the activation status of the Ringer 3 and can be either standalone or combined with another element, such as CPU 14. Timer 12 can be of the type used to keep track of talk time or to set the alarm in the cell phone and can continuously keep track of the on/off status of the ringer as time goes by. Integrated with Timer 12 or CPU 14 is an internal clock (not separately shown). The cell phone 10 communicates via RF wireless transmission with a base station subsystem (BSS) 20 of a cellular telephone network. The BSS 20 is connected, typically via a landline connection, to a Mobile Switching Office (MSO) 30 of the network operator. BSS 20 and MSO 30 are part of a communication network. A user is able to make telephone calls from the cell phone 10 in a known manner.

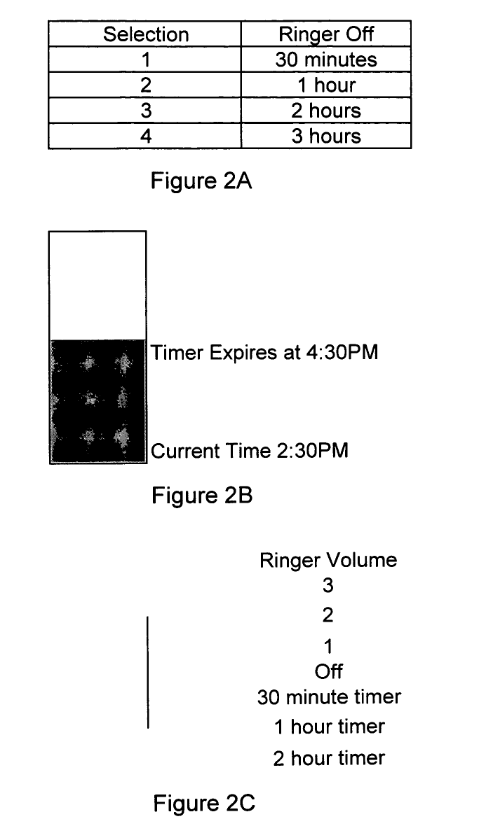

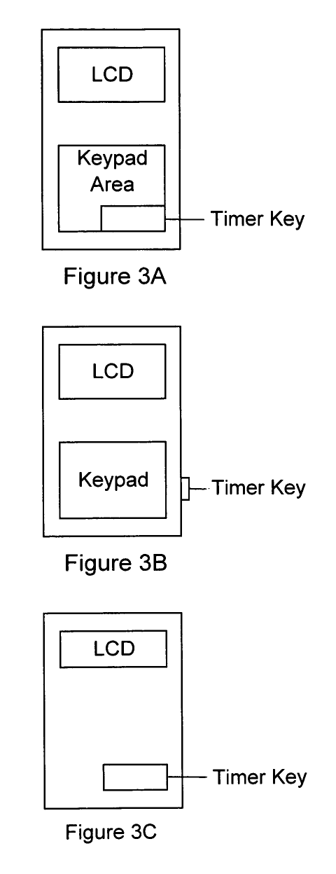

Two types of user input are required to activate the timer function for the ringer. The first input is to initiate the timer activation process and can be simply pressing a special key designated for timer activation (“timer key”). The second input is to specify the amount of time for the timer. The simplest embodiment is to combine both types of input into one, e.g., pressing a timer key to turn off the ringer, say, for the next one hour. It may be a specific key labeled “timer” in or near the keypad area. Once the key is pressed, the timer is set immediately, say, for the next one hour, during which the ringer will be turned off, and incoming calls will not cause it to ring. Another embodiment is to prompt the user to enter the timer period in a specific unit of time (e.g., minute or hour). The user would then enter, say, “2” to designate two hours. It may not be necessary to push another key, such as “OK” or “Send”, to signify the end of user input if the number of digits to be entered is fixed. Alternately, one may press a separate key to indicate that the time period entered is in hour or minute, e.g., “2” followed by “h” (i.e., the number 4 key) for two hours and “30” followed by “m” (i.e., the number 6 key) for 30 minutes. If speech recognition is used, the user may simply state the time period after or while pressing the timer key. Alternately, the user may be given a menu of available choices on the LCD screen, as shown in FIG. 2A or may enter/select the timer amount via some type of graphical user interface, an example of which is shown in FIG. 2B, where the timer amount is displayed as a shaded area (along with the expiration time in HH;MM format) as the user enters his input with the up/down key(s). Yet another embodiment is to enter the specific start and expiration times of the timer in HH:MM format (e.g., “4” or “04” followed by “30” for 4:30 followed by another key representing PM) after the timer key is pressed. Regardless of the methods used to activate the timer, the LCD display may show the current status of the timer (e.g., “Ringer off for next X minutes”) and may be updated continuously as time passes. The timer data (such as whether or not the timer is currently on and when it expires) may be stored in the cell phone (as shown in FIG. 1) or in the communication network (e.g., as part of the BSS 20 or MSO 30). The timer key can be placed in the keypad area (FIG. 3A), on the side of the phone (FIG. 3B), or on the top face of the phone for phones that can be folded or closed (FIG. 3C).

The ringer volume control key, often found on the side of modern cell phones, may serve as the timer key so that the user may turn off the ringer, say, for the next 30 minutes by pressing it one more time after the ringer is turned off or 1 hour by pressing two more times and so on. As illustrated in FIG. 2C, if the current ringer volume is set at 2, the user would press the ringer volume control key downward four times to set the timer at 1 hour.

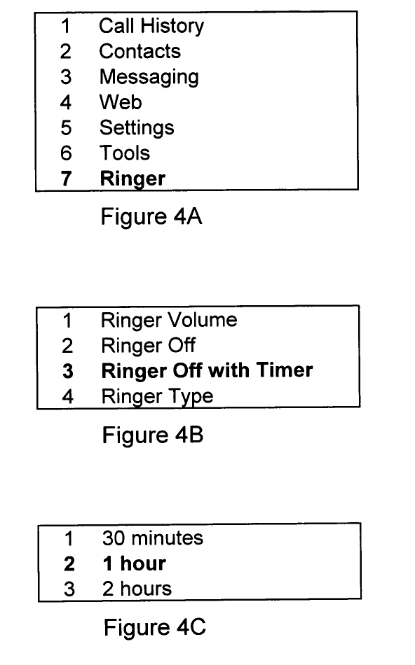

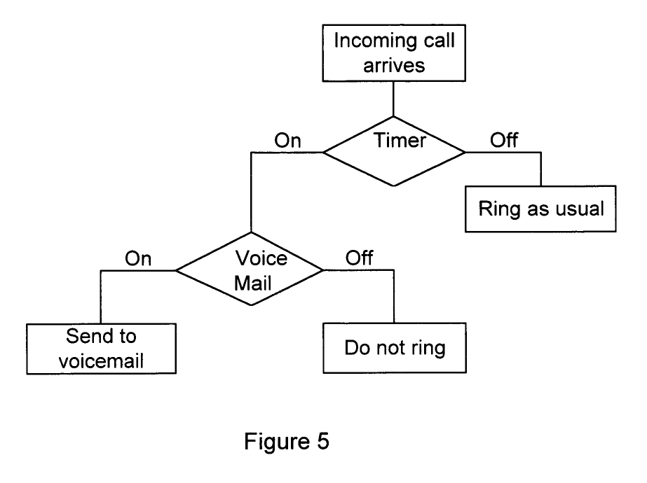

As an alternative embodiment, the user may traverse a menu of options, instead of a timer key, to initiate timer activation. For example, the user may select option 7 on the first menu (FIG. 4A), followed by option 3 (FIG. 4B) and then option (FIG. 4C) to turn off the ringer for one hour, without having to manually enter the start and end times of the timer period in numeric form.

A number of options may be provided to provide more user control. For example, the user may be prompted for the mode (e.g., silence, vibration or flash) in which the ringer should be placed while it's temporarily turned off during the timer period. However, for simplicity, the ringer may be put in vibration or flash mode by default when it's turned off. The user may also be given the option to turn off the ringer, turn off the phone or put the phone in sleep mode for a specific time period by using the timer. A mechanism can be provided to cancel the timer. For example, the same timer key of FIGS. 3A-3C may be used to both turn on and off the timer like a toggle switch.

FIG. 5 shows a typical call flow in connection with the use of the timer function. When there is an incoming call, the call is processed as usual by the network. Upon receiving signals for the incoming call, the CPU 14 checks with the Timer 12 to control (i.e., ring or not ring) the ringer based on whether the ringer is currently on or off. If the ringer is on (i.e., the timer is off or has otherwise expired), the call is processed as usual and the ringer will ring as usual. If the ringer is off (timer is on and has not expired), the ringer will not ring for the user, and the caller will perceive that the phone is ringing but is not being picked up. If the user has voicemail, the caller (after hearing so many rings) will be prompted to leave a voicemail. If the timer is stored in the network such as the Mobile Switching Office (MSO 20 of FIG. 1) with the Home Location Register (HLR) and/or Visitor Location Register (VLR) functionality, the MSO can advantageously direct all incoming calls to the user's voicemail immediately (without the user hearing any ringing, as if the user's phone were turned off completely).

While the invention is described in the context of cell phones receiving live voice calls, it is equally applicable to any portable communication devices, such as pagers, personal digital assistants (PDAs), MP players, video game consoles, handheld computers, tablet PCs and laptops, as long as they have alerting mechanisms (which are broadly referred to as ringers in this specification) for incoming messages. Messages can be email, instant messaging, voicemail, fax, video mail, live chat sessions, etc. Ringers can be audible, visual, vibrating or of any other form as long as it can be used as an alerting mechanism. Wireless phones can use any type of protocol, including GSM, G3, TDMA and CDMA, and can be terrestrial or satellite-based.

I claim:

1. A wireless phone whose ringer can be turned off by the user for a specific amount of time, comprising:
a. a ringer for notifying the user of an incoming call,
b. a user input device for entering a specific amount of time that said ringer is to be temporarily turned off,
c. a timer for keeping track of the on/off status of said ringer, and
d. a processor for controlling said ringer in accordance with said timer when an incoming call arrives.

2. The device according to claim 1, wherein said amount of time is entered in a specific unit or units of time, comprising one or more of minute, hour and day.

3. The device according to claim 1, wherein said amount of time is entered by selecting from a set of options corresponding to different amounts of time.

4. The device according to claim 1, wherein said amount of time is entered in graphical user interface.

5. The device according to claim 1, wherein said ringer is put in vibration mode when turned off.

6. The device according to claim 1, wherein said ringer is put in flash mode when turned off.

7. A wireless phone whose ringer can be turned off temporarily by the user, comprising:
a. a ringer for notifying the user of an incoming call,
b. a special key for initiating said user request to temporarily turn off said ringer,
c. a timer for keeping track of the on/off status of said ringer, and
d. a processor for controlling said ringer in accordance with said timer when an incoming call arrives.

8. The device according to claim 7, wherein said special key is the ringer volume control key.

9. The device according to claim 7, wherein said special key is disposed in the keypad area, on the side of the phone, or on the face of the phone in closed position.

10. The device according to claim 7, wherein said special key is used to enter or select the amount of time during which said ringer is to be turned off.

11. The device according to claim 7, wherein said ringer is put in vibration mode when turned off.

12. The device according to claim 7, wherein said ringer is put in flash mode when turned off.

13. A method of turning off the ringer of a portable communication device operating in a communication network, comprising the steps of:
a. entering the specific amount of time during which said ringer is to be temporarily turned off,
b. keeping track of the on/off status of said ringer, and
c. controlling said ringer in accordance with said on/off status when an incoming message arrives.

14. The method according to claim 13, wherein said amount of time is entered in a specific unit or units of time, comprising one or more of minute, hour and day.

15. The method according to claim 13, wherein said keeping track step is performed by said portable communication device.

16. The method according to claim 13, wherein said keeping track step is performed by said communication network.

17. The method according to claim 13, wherein said incoming message is a voice mail.

18. The method according to claim 13, wherein said incoming message is a video mail, an electronic mail, a facsimile message or a multimedia message.

19. The method according to claim 13, wherein said incoming message is an electronic chat session.

20. The method according to claim 13, wherein said ringer is placed in vibration or flash mode when turned off.

21. A portable communication device whose ringer can be turned off temporarily by the user, comprising:
a. a ringer for notifying the user of an incoming message,
b. a special key for initiating user request to temporarily turn off said ringer,
c. a timer for keeping track of the on/off status of said ringer,
d. a processor for controlling said ringer in accordance with said timer when an incoming message arrives.

22. The device according to claim 21, wherein said incoming message is a voice mail, a video mail, an electronic mail, a facsimile message, or a multimedia message.

23. The device according to claim 21, wherein said incoming message is an electronic chat session.

24. The device according to claim 21, wherein said ringer is placed in vibration or flash mode when turned off.
